(19) United States
(12) Patent Application Publication
(10) Pub. No.: US 2026/0212541 A1
(43) Pub. Date: Jul. 23, 2026

(54) DELAYED TRANSLATION OF GENERATIVE AI ASSETS

(71) Applicant: AUTODESK, INC., San Francisco, CA (US)

(72) Inventors: George William FITZMAURICE, Toronto (CA); Jo Karel VERMEULEN, East York (CA); Justin Frank MATEJKA, Newmarket (CA)

(21) Appl. No.: 19/291,418

(22) Filed: Aug. 5, 2025

Related U.S. Application Data
(60) Provisional application No. 63/747,822, filed on Jan. 21, 2025.

(51) Int. Cl. G06T 11/00

(52) U.S. Cl. CPC G06T 11/00; G06T 2210/36

(57) ABSTRACT

Various embodiments include a computer-implemented method for generating designs, including generating a proxy object within an intermediate design based on a first prompt, generating a first resolved object within the intermediate design based on a second prompt, determining that the proxy object can be replaced with a second resolved object based on a design context associated with the intermediate design, and generating the second resolved object based on the first resolved object and the design context.

### CROSS-REFERENCE TO RELATED APPLICATIONS

The present application claims priority benefit of the U.S. Provisional Patent Application titled, “DELAYED TRANSLATION OF GENERATIVE AI ASSETS,” having Ser. No. 63/747,822 and filed on Jan. 21, 2025. The subject matter of this related application is hereby incorporated herein by reference.

### BACKGROUND

### Field of the Various Embodiments

The present disclosure relates generally to computer science, artificial intelligence, and complex software and, more specifically, to delayed translation of generative AI assets.

### Description of the Related Art

In a conventional computer-aided design (CAD) workflow, a designer uses various tools included in a CAD program to generate or assemble design elements for a design. The design elements could include, for example, two-dimensional (2D) images or three-dimensional (3D) geometry, among other types of design elements. Typically, the tools provided by the CAD program allow the designer to manually specify various attributes of the design elements or manipulate existing attributes of the design elements in an iterative and incremental manner. Some types of CAD programs now include machine learning models that implement generative artificial intelligence (AI) to automatically generate design elements based on high-level design criteria. A designer can simply describe high-level design criteria using natural language, and a machine learning model then automatically generates design elements to meet such design criteria. Generative AI is becoming increasingly integrated into modern CAD workflows.

One drawback associated with conventional generative AI tools is that when generating a design, such tools often generate design elements that are thematically inconsistent or functionally incompatible with other design elements already included in the design. For example, a CAD program with integrated generative AI tools might generate a mountain bike frame in response to a prompt received from a designer, and then subsequently add road bike tires to the mountain bike frame in response to another prompt received from the user, leading to a design composed of design elements that are both thematically inconsistent and functionally incompatible with one another. As a general matter, generative AI tools do not adequately consider pre-existing context included in a design when generating additional design elements to be included in the design.

As the foregoing illustrates, what is needed in the art is a more effective technique for generating design elements using generative AI.

### SUMMARY

Various embodiments include a computer-implemented method for generating designs, including generating a proxy object within an intermediate design based on a first prompt, generating a first resolved object within the intermediate design based on a second prompt, determining that the proxy object can be replaced with a second resolved object based on a design context associated with the intermediate design, and generating the second resolved object based on the first resolved object and the design context.

At least one technical advantage of the disclosed techniques relative to the prior art is that the disclosed techniques enable the generation of designs having design elements that are thematically consistent and functionally compatible with one another. Accordingly, the design engine can avoid the generation of designs with design elements that do not belong together or appear out of place relative to other design elements included in the design. Another technical advantage of the disclosed techniques is that design elements can be modified in response to design changes in order to maintain thematic consistency and functional compatibility with other design elements. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a system configured to implement one or more aspects of the invention;

FIG. 2 is a more detailed illustration of the design engine of FIG. 1, according to various embodiments;

FIG. 3 illustrates how the design engine of FIGS. 1-2 delays generation of an object included in a design, according to various embodiments;

FIG. 4 illustrates how the design engine of FIGS. 1-2 generates different resolved objects based on different design contexts, according to various embodiments;

FIG. 5 illustrates how the design engine of FIGS. 1-2 modifies an object in response to a change in design context, according to various embodiments;

FIG. 6 illustrates how the design engine of FIGS. 1-2 generates portions of a document based on other portions of the document, according to various embodiments; and

FIG. 7 is a flow diagram of methods steps for resolving objects in designs based on a design context, according to various embodiments.

### DETAILED DESCRIPTION OF EXEMPLARY EMBODIMENTS

In the following description, numerous specific details are set forth to provide a more thorough understanding of the various embodiments. However, it will be apparent to one skilled in the art that the inventive concepts may be practiced without one or more of these specific details.

### System Overview

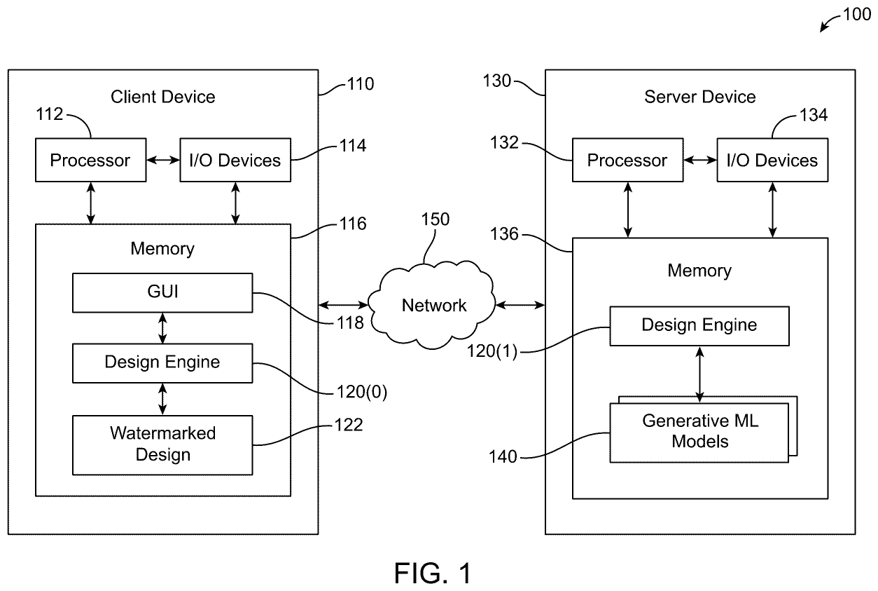

FIG. 1 illustrates a system configured to implement one or more aspects of the various embodiments. As shown, a system 100 includes a client device 110 and a server device 130 coupled together via a network 150. Client device 110 or server device 130 may be any technically feasible type of computer system, including a desktop computer, a laptop computer, a mobile device, a virtualized instance of a computing device, a distributed and/or cloud-based computer system, and so forth. Network 150 may be any technically feasible set of interconnected communication links, including a local area network (LAN), wide area network (WAN), the World Wide Web, or the Internet, among others.

As further shown, client device 110 includes a processor 112, input/output (I/O) devices 114, and a memory 116, coupled together. Processor 112 includes any technically feasible set of hardware units configured to process data and execute software applications. For example, and without limitation, processor 112 could include one or more central processing units (CPUs) and/or one or more graphics processing units (GPUs). I/O devices 114 include any technically feasible set of devices configured to perform input and/or output operations, including, for example and without limitation, a display device, a keyboard, and/or a touchscreen, among others.

Memory 116 includes any technically feasible storage media configured to store data and software applications, such as, for example and without limitation, a hard disk, a random-access memory (RAM) module, and/or a read-only memory (ROM). Memory 116 includes a graphical user interface (GUI) 118, a design engine 120(0), and a resolved design 122. Design engine 120(0) is a software application that, when executed by processor 112, interoperates with a corresponding design engine executing on server device 130 to generate resolved design 122 based on input received from a user via GUI 118. GUI 118 includes user interface elements that, when displayed to a user via a display device, allow a user to provide various types of input and receive various types of output.

Server 130 includes a processor 132, I/O devices 134, and a memory 136, coupled together. Processor 132 includes any technically feasible set of hardware units configured to process data and execute software applications, such as one or more CPUs and/or one or more GPUs. I/O devices 134 include any technically feasible set of devices configured to perform input and/or output operations, such as, for example and without limitation, a display device, a keyboard, and/or a touchscreen, among others.

Memory 136 includes any technically feasible storage media configured to store data and software applications, such as, for example and without limitation, a hard disk, a RAM module, and/or a ROM. Memory 136 includes a design engine 120(1) and one or more generative machine learning (ML) models 140. Generative ML models 140 are trained using vast amounts of data to process to multi-modal prompts using techniques associated with generative AI. Generative ML models 140 can include large language models (LLMs), visual language models (VLMs), other transformer-based models, deep neural networks (DNNs), convolutional neural networks (CNNs), or any other technically feasible set of algorithms configured to generate design elements for designs based on natural language and/or other inputs. The design elements could include, for example and without limitation, two-dimensional (2D) images and/or three-dimensional (3D) geometry, In one embodiment, generative ML models 140 may be configured to interact with one or more application programming interface (API) endpoints in order to transmit prompts and receive responses from other ML models located on one or more remote servers.

Design engine 120(1) is a software application that, when executed by processor 132, interoperates with design engine 120(0) executing on client 110 to coordinate any of the different operations described herein. Design engines 120(0) and 120(1) represent distinct portions of a distributed software entity that is configured to perform any and all of the various operations described herein. Thus, for simplicity, design engines 120(0) and 120(1) are collectively referred to hereinafter as design engine 120.

Design engine 120 is configured to interact with GUI 118 in order to expose a CAD environment to a user via which the user can provide input for generating 2D and/or 3D designs. In operation, design engine 120 receives prompts from the user that describe various design elements, and design engine 120 then incrementally builds an intermediate design that includes both proxy objects as well as resolved objects. Proxy objects act as placeholders and are converted into resolved objects once the design includes sufficient design context. Design engine 120 also analyzes the design and generates resolved objects based on proxy objects in response to changes in the design context. Design engine 120 resolves all proxy objects to generate resolved design 122. By delaying the resolution of design elements in this manner, design engine 120 can generate designs with design elements that are thematically consistent and/or functionally compatible with one another.

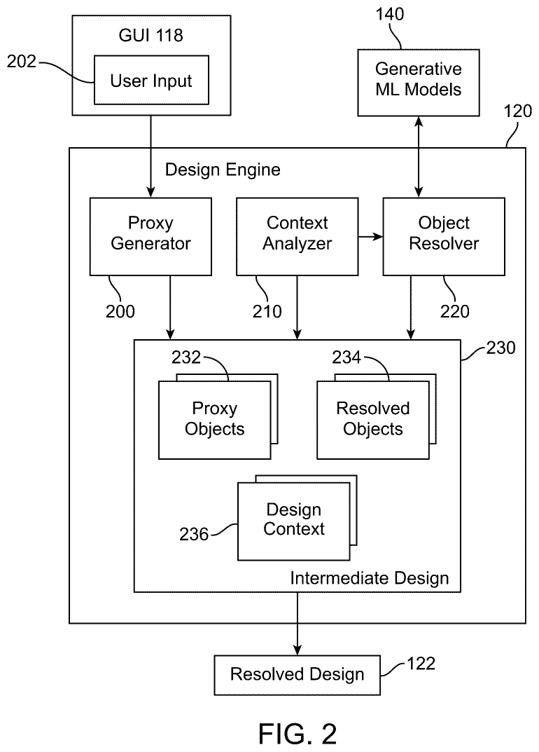

As referred to herein, a set of design elements may be considered thematically consistent with each other when such design elements share a common construction style, adhere to a given trend, have any number of features in common, or originate from the same time period, among other possibilities. Similarly, a set of design elements may be considered functionally compatible with each other when such design elements can physically operate together in the context of a given system, are mechanically tuned to one another, or are electronically suited to operate together, among other possibilities. The various operations performed by design engine 120 are described in greater detail below in conjunction with FIG. 2.

FIG. 2 is a more detailed illustration of the design engine of FIG. 1, according to various embodiments. As shown, design engine 120 includes a proxy generator 200, a context analyzer 210, an object resolver 220, and an intermediate design 230. Proxy generator 200 receives user input 202 from the user via GUI 118. GUI 118 can include any technically feasible set of interactive elements configured to receive input from and present output to the user. User input 202 can include any technically feasible form of data provided by the user. In practice, user input 202 includes one or more prompts that describe specific design elements to be included in a design. Proxy generator 200 is configured to analyze user input 202 and determine that a proxy object 232 should be included in intermediate design 230. In one embodiment, proxy generator 200 may determine that a proxy object should be generated based on a level of detail associated with the prompt received from the user. In other embodiments, the user can specify that a proxy object should be generated. GUI 118 can display proxy object 232 as a generic object with cursory detail or as any technically feasible visual indicator placed at a specific location within intermediate design 230.

Context analyzer 210 analyzes intermediate design 230 on a continuous basis and generates and/or updates design context 236 to reflect changes in intermediate design 230. In one embodiment, context analyzer 210 may accumulate prompts received from the user in design context 236. In another embodiment, context analyzer 210 generates a description of intermediate design 230 via ML models 140 and includes the description in design context 236. As design context 236 evolves during the design process, context analyzer 210 analyzes design context 236 and determines whether sufficient contextual information is included in intermediate design 230 to merit converting one or more proxy objects 232 into one or more corresponding resolved objects 234. For example, and without limitation, context analyzer 210 could determine that sufficient background imagery is present in intermediate design 230 such that one or more foreground elements, temporarily represented as proxy objects 232, can be resolved. In various embodiments, context analyzer 210 processes design context 236 via one or more ML models 140 to determine and evaluate a current level of context.

When context analyzer 210 determines that intermediate design 230 includes sufficient context, object resolver 220 analyzes intermediate design 230 and then implements ML models 140 to generate one or more resolved objects 234 that can replace corresponding proxy objects 232. In so doing, object resolver 220 provides design context 236 to ML models 140 so that ML models 140 can generate resolved objects 234 that are thematically consistent and/or functionally compatible with other resolved objects 234 included within intermediate design 230. In various embodiments, proxy object 232 is retained when a corresponding resolved object 234 is generated, thereby allowing object resolver 220 to generate additional versions of resolved objects 234 in response to changes in design context 236.

In some embodiments, proxy generator 200, context analyzer 210, and object resolver 220 may interoperate in order to determine whether a proxy object 232 or a resolved object 234 should be generated based on a degree of additional context provided in a prompt received from the user. For example, and without limitation, context analyzer 210 could determine that a given prompt only specifies minimal detail associated with an object, and then cause proxy generator 200 to generate a proxy object 232 that includes those minimal details. Conversely, context analyzer 210 could determine that the prompt includes a deeper level of detail describing an object, and then cause object resolver 220 to proceed with generating a resolved object 234 based on those details. In this manner, object resolver 220 can directly generate resolved objects 234 within intermediate design 230 without proxy generator 200 first generating a proxy object 232.

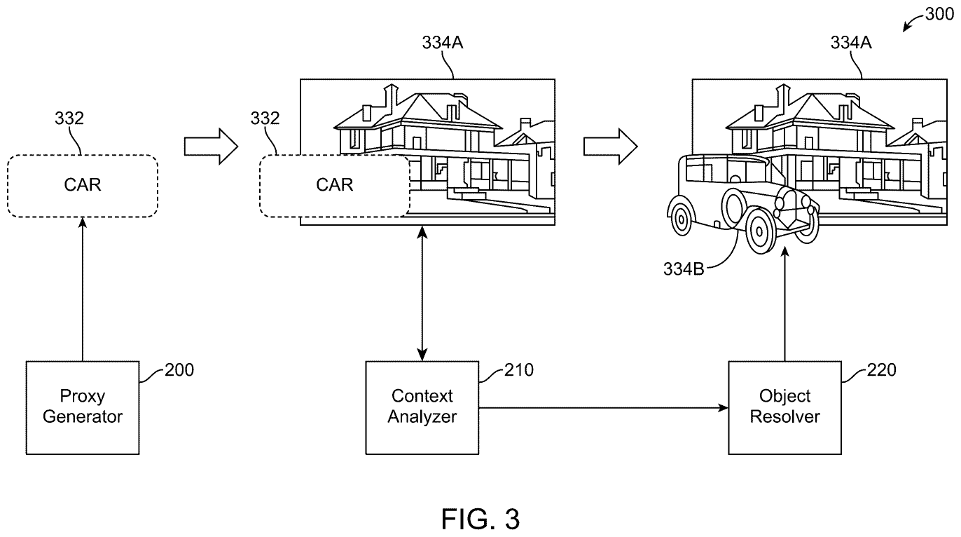

Once all proxy objects 232 are replaced with resolved objects 234, design engine 120 generates resolved design 122. By delaying the translation of proxy objects 232 in this manner until a given level of context is reached, design engine 120 can facilitate the generation of designs with greater internal consistency than possible compared to conventional techniques. FIGS. 3-6 set forth different examples of how design engine 120 performs the techniques described thus far.

FIG. 3 illustrates how the design engine of FIGS. 1-2 delays generation of an object included in a design, according to various embodiments. As shown, proxy generator 200, context analyzer 210, and object resolver 220 interoperate across a series of stages 300. Initially, proxy generator 200 generates a proxy object 332 labeled “CAR.” Proxy object 332 is a generic placeholder that includes cursory information derived from a minimally-detailed prompt received from the user. Proxy object 332 cannot be resolved into a specific type of car yet because insufficient context is present.

Subsequently, the user provides a prompt with enough detail that object resolver 220 can directly generate a resolved object 334A representing background imagery. As mentioned above, proxy generator 200, context analyzer 210, and object resolver 220 can interoperate to generate resolved objects in response to prompts received from the user when those prompts provide a sufficient level of context. Context analyzer 210 updates design context 236 in response to the addition of resolved object 334A and then causes object resolver 220 to replace proxy object 332 with resolved object 334B. In the example shown, context analyzer 210 determines that the background imagery corresponds to a particular time period, and then replaces proxy object 332 with a specific type of car associated with that time period. In this manner, design engine 120 can generate designs with a higher degree of coherency relative to conventional techniques.

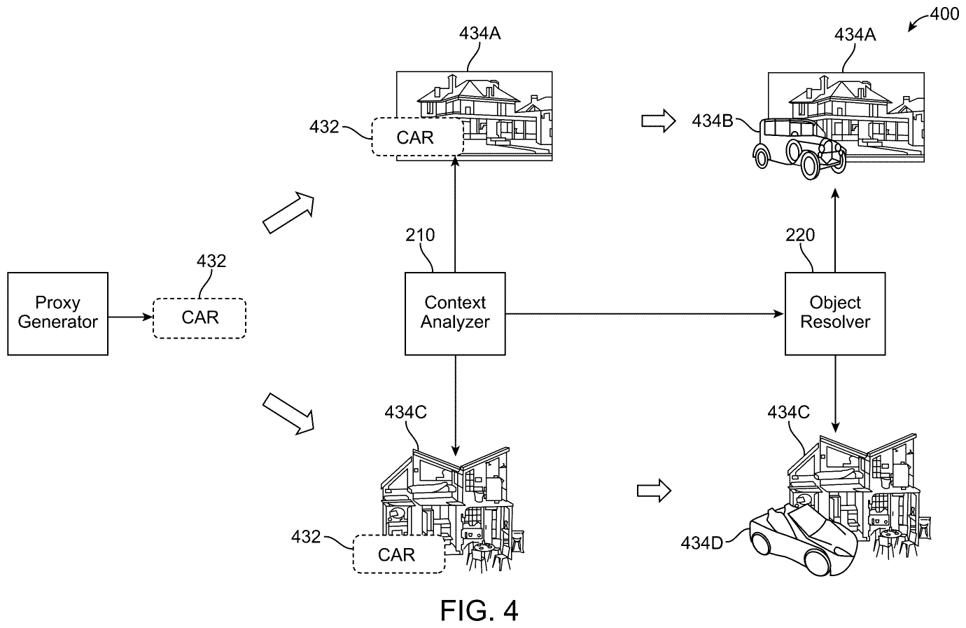

FIG. 4 illustrates how the design engine of FIGS. 1-2 generates different resolved objects based on different design contexts, according to various embodiments. As shown, proxy generator 200, context analyzer 210, and object resolver 220 interoperate across a series of stages 400 to generate different versions of a design. Initially, proxy generator 200 generates a proxy object 332 labeled “CAR,” similar to the example described above in conjunction with FIG. 3. Proxy object 332 can then be resolved in different ways depending on additionally added context.

In particular, object resolver 220 can resolve proxy object 432 based on resolved object 434A to generate resolved object 434B, in a manner similar to that described above in conjunction with FIG. 3. Here, the addition of background imagery associated with a given theme provides sufficient context for proxy object 432 to be resolved with a similar theme. Alternatively, object resolver 220 can resolve proxy object 432 based on resolved object 434C to generate resolved object 434D. Resolved object 434D is a markedly different style of car compared to resolved object 434B, but resolved object 434D has a style that is thematically consistent with resolved object 434C. In the manner described, the different components of design engine 120 can generate variations in designs that are internally consistent but thematically different from one another.

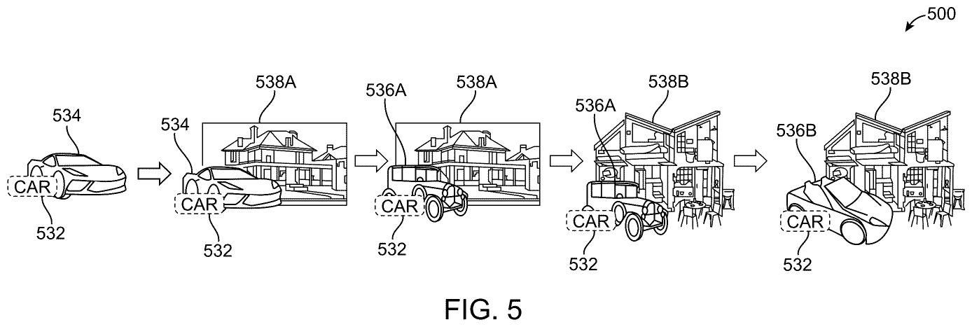

FIG. 5 illustrates how the design engine of FIGS. 1-2 modifies an object in response to a change in design context, according to various embodiments. As shown, proxy generator 200 initially generates a proxy object 532, and object resolver 220 also generates a resolved object 534. Resolved object 534 represents a first attempt at resolving proxy object 532. Subsequently, additional background imagery is added via resolved object 538A, thereby providing a deeper level of context. Context analyzer 210 updates design context 536 and then determines that resolved object 534 has a style that is inconsistent with the background imagery presented via resolved object 538A. Accordingly, object resolver 220 replaces resolved object 534 with resolved object 536A, which has a style that is consistent with the background imagery presented via resolved object 538A. Following additional changes to the background imagery, resolved object 538A is replaced with resolved object 538B. In response, context analyzer 210 determines that additional updates are needed, so object resolver 220 replaces resolved object 536A with resolved object 536B, thereby reducing inconsistencies between objects as the design context changes.

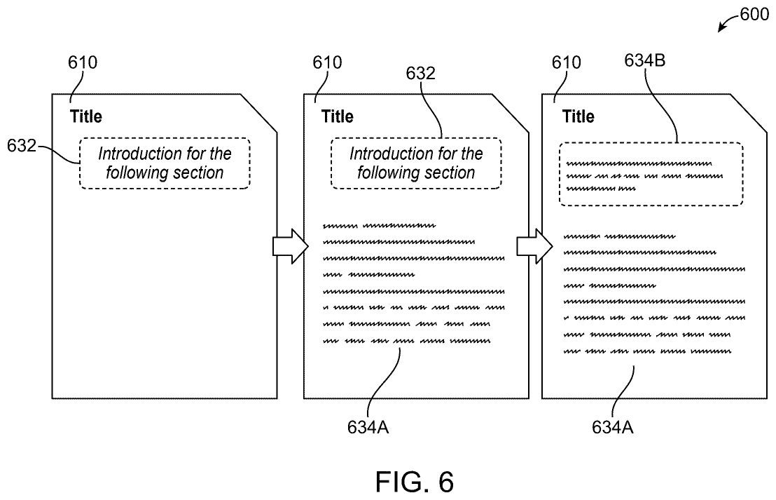

FIG. 6 illustrates how the design engine of FIGS. 1-2 generates portions of a document based on other portions of the document, according to various embodiments. The techniques described thus far can also be applied to generating documents. As shown, design engine 120 generates a document 610 across a series of stages 300. Initially, proxy generator 200 generates a proxy paragraph 632 representing an introduction to a document that is not yet written. Subsequently, the user adds content 634A. With the addition of contextual details provided by such content, context analyzer 210 determines that proxy paragraph 632 can be updated, and object resolver 220 then generates resolved paragraph 634B.

Referring generally to FIGS. 3-6, any of the operations described thus far can be implemented via interactions between the different components of design engine 120 and one or more ML models 140. Persons skilled in the art will understand that different types of ML models may be appropriate for the different types of operations described herein, and that any relevant ML model can be implemented in order to perform any particular operation.

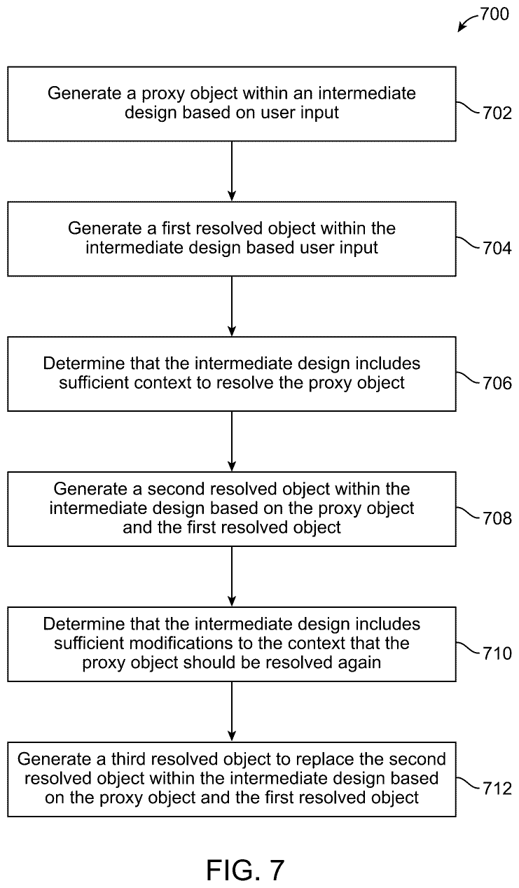

FIG. 7 is a flow diagram of method steps for resolving objects in designs based on a design context, according to various embodiments. Although the method steps are described in conjunction with the systems of FIGS. 1-6, persons skilled in the art will understand that any system configured to perform the method steps, in any order, is within the scope of the present embodiments.

As shown, a method 700 begins at step 702, where proxy generator 200 within design engine 120 generates a proxy object within an intermediate design based on user input. In one embodiment, proxy generator 200 may determine that a proxy object should be generated based on a level of detail associated with the prompt received from the user. In other embodiments, the user can specify that a proxy object should be generated. In further embodiments, proxy generator 200, context analyzer 210, and object resolver 220 interoperate to determine whether a proxy object should be generated.

At step 704, object resolver 220 generates a first resolved object within the intermediate design based on user input. The first resolved object generally includes a sufficient level of context that a proxy object need not be generated as a placeholder. For example, as described above in conjunction with FIGS. 3-5, the first resolved object could be a background image that is described with sufficient detail for a reasonably accurate version to be generated. In some embodiments, background imagery or other design elements can simply be chosen by the user.

At step 706, context analyzer 210 determines that the intermediate design includes sufficient context to resolve the proxy object. In so doing, context analyzer 210 generates design context 236 in order to track the evolution of the intermediate design during the design process. In one embodiment, context analyzer 210 determines that sufficient context is present in the intermediate design by causing an ML model 140 to evaluate design context 236.

At step 708, object resolver 220 generates a second resolved object within the intermediate design based on the proxy object and the first resolved object. Object resolver 220 can replace the proxy object with the second resolved object or retain the proxy object. Object resolver 220 implements ML models 140 in order to generate the second resolved object to have thematic and/or functional attributes that are consistent with the first resolved object. For example, suppose the first resolved object represents an antique timepiece and the second resolved object represents a gear within that timepiece. Object resolver 220 could generate the gear to have a construction style that is consistent with other components of the timepiece, and also generate the gear to have functional characteristics that are mechanically compatible with the timepiece.

At step 710, context analyzer 210 determines that the intermediate design includes sufficient modifications to the design context that the proxy object should be resolved again. Context analyzer 210 analyzes the intermediate design on a continuous basis to generate and/or update the design context to reflect changes in that design. In one embodiment, context analyzer 210 may accumulate prompts received from the user in design context 236. In another embodiment, context analyzer 210 generates a description of intermediate design 230 via ML models 140 and includes the description in design context 236. As design context 236 evolves during the design process, context analyzer 210 evaluates the design context to determine a current level of contextual depth and/or breadth.

At step 712, object resolver 220 generates a third resolved object to replace the second resolved object within the intermediate design based on the proxy object and the first resolved object. The third resolved object has thematic features and/or functional characteristics that are more consistent with the current design context than those of the second resolved object. Accordingly, object resolver 220 operates to bring different objects included in the intermediate design into a state of consistency with one another. Once all proxy objects are resolved, design engine 120 outputs resolved design 122.

In sum, a design engine includes a proxy generator that incorporates proxy objects into a design based on prompts received from a designer. The proxy objects act as placeholders and initially are not resolved into actual design elements. The design engine further includes a context analyzer that analyzes the design as the design evolves and determines when the design includes enough context such that the proxy objects can be resolved. The design engine also includes an object resolver that replaces the proxy objects with resolved objects once the context analyzer determines that sufficient context exists in the design. During the design process, the context analyzer analyzes the context of the design on an ongoing basis. Such ongoing analysis causes the object resolver to iteratively resolve objects in the design, including both proxy objects and resolved objects, in response to changes in the design.

At least one technical advantage of the disclosed techniques relative to the prior art is that the disclosed techniques enable the generation of designs having design elements that are thematically consistent and functionally compatible with one another. Accordingly, the design engine can avoid the generation of designs with design elements that do not belong together or appear out of place relative to other design elements included in the design. Another technical advantage of the disclosed techniques is that design elements can be modified in response to design changes in order to maintain thematic consistency and functional compatibility with other design elements. These technical advantages provide one or more technological advancements over prior art approaches.
1. Some embodiments include a computer-implemented method for generating designs, the method comprising generating a proxy object within an intermediate design based on a first prompt, generating a first resolved object within the intermediate design based on a second prompt, determining that the proxy object can be replaced with a second resolved object based on a design context associated with the intermediate design, and generating the second resolved object based on the first resolved object and the design context.
2. The computer-implemented method of clause 1, wherein generating the proxy object comprises updating the intermediate design to include at least a portion of the first prompt.
3. The computer-implemented method of any of clauses 1-2, wherein generating the first resolved object comprises generating one or more images based on the second prompt.
4. The computer-implemented method of any of clauses 1-3, further comprising generating the design context based on the first prompt and the second prompt.
5. The computer-implemented method of any of clauses 1-4, further comprising generating the design context by generating a description of the intermediate design.
6. The computer-implemented method of any of clauses 1-5, wherein determining that the proxy object can be replaced comprises evaluating a level of detail associated with the intermediate design based on the design context.
7. The computer-implemented method of any of clauses 1-6, wherein the second resolved object is thematically consistent with the first resolved object.
8. The computer-implemented method of any of clauses 1-7, wherein the second resolved object is functionally compatible with the first resolved object.
9. The computer-implemented method of any of clauses 1-8, further comprising determining that the first prompt does not include sufficient detail to generate a resolved object, and in response, generating the proxy object.
10. The computer-implemented method of any of clauses 1-9, further comprising determining that the second prompt includes sufficient detail to generate a resolved object, and in response, generating the second resolved object.
11. One or more non-transitory computer readable media storing instructions that, when executed by one or more processors, cause the one or more processors to generate designs by performing the steps of generating a proxy object within an intermediate design based on a first prompt, generating a first resolved object within the intermediate design based on a second prompt, determining that the proxy object can be replaced with a second resolved object based on a design context associated with the intermediate design, and generating the second resolved object based on the first resolved object and the design context.
12. The one or more non-transitory computer readable media of any of clauses 1-11, wherein the step of generating the proxy object comprises updating the intermediate design to include at least a portion of the first prompt.
13. The one or more non-transitory computer readable media of any of clauses 1-12, wherein the step of generating the first resolved object comprises generating one or more images based on the second prompt.
14. The one or more non-transitory computer readable media of any of clauses 1-13, further comprising the step of generating the design context based on the first prompt and the second prompt by generating a description of the intermediate design.
15. The one or more non-transitory computer readable media of any of clauses 1-14, wherein the step of determining that the proxy object can be replaced comprises evaluating a level of detail associated with the intermediate design based on the design context.
16. The one or more non-transitory computer readable media of any of clauses 1-15, wherein the second resolved object is thematically consistent with the first resolved object or functionally compatible with the first resolved object.
17. The one or more non-transitory computer readable media of any of clauses 1-16, further comprising the steps of determining that the second prompt includes sufficient detail to generate a resolved object, and in response, generating the second resolved object.
18. The one or more non-transitory computer readable media of any of clauses 1-17, wherein the first resolved object comprises a first portion of a document, and the second resolved object comprises a second portion of the document.
19. The one or more non-transitory computer readable media of any of clauses 11 further comprising the steps of generating an updated design context based on user input, generating a third resolved object based on the updated design context, and replacing the second resolved object with the third resolved object.
20. Some embodiments include a computer system, comprising one or more memories that include instructions, and one or more processors that are coupled to the one or more memories and, when executing the instructions, are configured to generate designs by generating a proxy object within an intermediate design based on a first prompt, generating a first resolved object within the intermediate design based on a second prompt, determining that the proxy object can be replaced with a second resolved object based on a design context associated with the intermediate design, and generating the second resolved object based on the first resolved object and the design context.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating designs, the method comprising:
generating a proxy object within an intermediate design based on a first prompt;
generating a first resolved object within the intermediate design based on a second prompt;
determining that the proxy object can be replaced with a second resolved object based on a design context associated with the intermediate design; and
generating the second resolved object based on the first resolved object and the design context.

2. The computer-implemented method of claim 1, wherein generating the proxy object comprises updating the intermediate design to include at least a portion of the first prompt.

3. The computer-implemented method of claim 1, wherein generating the first resolved object comprises generating one or more images based on the second prompt.

4. The computer-implemented method of claim 1, further comprising generating the design context based on the first prompt and the second prompt.

5. The computer-implemented method of claim 1, further comprising generating the design context by generating a description of the intermediate design.

6. The computer-implemented method of claim 1, wherein determining that the proxy object can be replaced comprises evaluating a level of detail associated with the intermediate design based on the design context.

7. The computer-implemented method of claim 1, wherein the second resolved object is thematically consistent with the first resolved object.

8. The computer-implemented method of claim 1, wherein the second resolved object is functionally compatible with the first resolved object.

9. The computer-implemented method of claim 1, further comprising:
determining that the first prompt does not include sufficient detail to generate a resolved object; and
in response, generating the proxy object.

10. The computer-implemented method of claim 1, further comprising:
determining that the second prompt includes sufficient detail to generate a resolved object; and
in response, generating the second resolved object.

11. One or more non-transitory computer readable media storing instructions that, when executed by one or more processors, cause the one or more processors to generate designs by performing the steps of:
generating a proxy object within an intermediate design based on a first prompt;
generating a first resolved object within the intermediate design based on a second prompt;
determining that the proxy object can be replaced with a second resolved object based on a design context associated with the intermediate design; and
generating the second resolved object based on the first resolved object and the design context.

12. The one or more non-transitory computer readable media of claim 11, wherein the step of generating the proxy object comprises updating the intermediate design to include at least a portion of the first prompt.

13. The one or more non-transitory computer readable media of claim 11, wherein the step of generating the first resolved object comprises generating one or more images based on the second prompt.

14. The one or more non-transitory computer readable media of claim 11, further comprising the step of generating the design context based on the first prompt and the second prompt by generating a description of the intermediate design.

15. The one or more non-transitory computer readable media of claim 11, wherein the step of determining that the proxy object can be replaced comprises evaluating a level of detail associated with the intermediate design based on the design context.

16. The one or more non-transitory computer readable media of claim 11, wherein the second resolved object is thematically consistent with the first resolved object or functionally compatible with the first resolved object.

17. The one or more non-transitory computer readable media of claim 11, further comprising the steps of:
determining that the second prompt includes sufficient detail to generate a resolved object; and
in response, generating the second resolved object.

18. The one or more non-transitory computer readable media of claim 11, wherein the first resolved object comprises a first portion of a document, and the second resolved object comprises a second portion of the document.

19. The one or more non-transitory computer readable media of claim 11 further comprising the steps of:
generating an updated design context based on user input;
generating a third resolved object based on the updated design context; and
replacing the second resolved object with the third resolved object.

20. A computer system, comprising:
one or more memories that include instructions; and
one or more processors that are coupled to the one or more memories and, when executing the instructions, are configured to generate designs by:
generating a proxy object within an intermediate design based on a first prompt,
generating a first resolved object within the intermediate design based on a second prompt,
determining that the proxy object can be replaced with a second resolved object based on a design context associated with the intermediate design, and
generating the second resolved object based on the first resolved object and the design context.
